(19) United States
(12) Patent Application Publication
(10) Pub. No.: US 2007/0160341 A1
(43) Pub. Date: Jul. 12, 2007

(54) Video signal playback unit and video signal playback method

(76) Inventor: Yukihiro Yoshida, Tokyo (JP)

Correspondence Address: DICKSTEIN SHAPIRO LLP, 1825 EYE STREET NW, Washington, DC, 20006-5403, US

(21) Appl. No.: 10/587,655

(22) PCT Filed: Sep. 30, 2004
(86) PCT No.: PCT/JP04/14808

§ 371 Date: Jul. 28, 2006

(30) Foreign Application Priority Data
Feb. 3, 2004 (JP) 2004-026492
Jul. 20, 2004 (JP) 2004-211796

(51) Int. Cl. H04N 5/91

(52) U.S. Cl. 386/68

(57) ABSTRACT

A video signal playback unit includes a record and playback section (3) for recording and playing back image data, a skip operation section (6) for receiving skip playback instruction input resulting from user operation, a calculating section (8) for calculating, based on the skip playback instruction input being input from the skip operation section (6), a first time skipped a predetermined time from a playback time at the time of input, and a second time obtained by adding a predetermined time to the first time, and an output section (5) for outputting a first video signal for image data played back by the record and playback section (3), the first video data being corresponding to the first time calculated by the calculating section (8), and a second video signal for image data played back by the record and playback section (3), the second video data being corresponding to the second time calculated by the calculating section (8).

### TECHNICAL FIELD

The present invention relates to a video signal playback unit for playing back a video signal, and to a video signal playback method.

### BACKGROUND ART

In recent years, as video signal playback units for playing back video signals, DVD (Digital Versatile Disc) players accepting DVDs as a storage medium, and hard disk recorders having a hard disk as a storage medium, have become widespread.

A DVD recorder or a hard disc recorder can be accessed to a medium at high speed, which means that when carrying out skip playback where playback is carried out by skipping a predetermined time, differing from fast forward and rewind of a video player of the related art, it is possible to playback a video signal from a skip position in a short time. This type of skip playback is also applied to commercial skip playback where playback is performed so as to skip commercials (commercial messages) that are broadcast during a program, in the event that the television broadcast program has been recorded and played back. As a device provided with this type of skip function, there is developed an image recording and playback device (for example, Unexamined Japanese Patent Application Publication laid open No. 2002-152687: hereafter referred to as Patent document 1).

The image recording and playback device disclosed in patent document 1 is provided with a skip function for performing playback while skipping commercial parts included in a program of a television broadcast as a result of a viewer's inputting of a command for skip playback using a remote control or the like when playing back an image signal of a television broadcast stored in a storage medium.

With the image recording and playback device disclosed in patent document 1, if the viewer presses a skip key on the remote control after a commercial has started, a first given period of time (for example 12 seconds) is skipped when the skip key is pressed down the first time. In the event that the skip key is pressed down twice in succession, that is, when the skip key is pressed down and the skip key is pressed down before an image is displayed on the screen, there occurs a skip of a second given time (for example 15 seconds). When pressed down the skip key twice of more subsequent times, in the event that the skip key is pressed down with a given time (for example 3 seconds) from the time of pressing the skip key previously, skip is performed for a third given time (for example, 14 seconds).

### DISCLOSURE OF THE INVENTION

With the above described image recording and playback device disclosed in patent document 1, a predetermined time is skipped from the point in time where a skip key is pressed down, and it is possible to perform playback of a video signal from the skip position in a short time. However, since an image during skipping is not displayed on a display, similar with the fast forwarding and rewinding of a video player of the related art, it is difficult for the viewer to determine whether or not the skip position is the position where they want playback to commence.

For example, when playing back a television broadcast program that has been stored in a storage medium, commercials during the program are skipped. When the viewer presses down the skip key to cause a commercial to be skipped, in order to skip commercials, there are cases where the program has already started at the point skipped to. At this time, the viewer must search for the start position of the program after the commercial by watching the image while playing back in rewind mode to the program start position.

As one example, it is assumed that there is inserted a commercial from 1:28:00 pm until 1:29:59 pm, and a program starts from 1:30:00 pm, and that the viewer has pressed down the skip key several times to skip every 15 seconds from the start of the commercial, and presses the skip key at 1:29:58 pm. At this time, the time point skipped to is positioned at 1:30:13 pm, so playback commences from an image at the position that is 13 seconds after the end of the commercial.

Even if the skipped position is two seconds before the start of the program, the viewer cannot immediately determine that the program will start from the image displayed at that point in time. Therefore, the user will press down the skip button immediately before the start of the program and skip to a position that is a long way from the position where the program starts. In this case, the viewer rewinds the image for 13 seconds, and as well as requiring the effort of rewinding, it takes time from the desired position until viewing.

As described above, with the recording and playback device having the skip playback function, by pressing down the skip key the playback position is skipped for every predetermined time, and it is possible to start playback from a desired playback start position in a short time, but it is difficult to determine whether or not the skip position is close to the desired playback start position based on an image at the skip point. As a result, in the case of skip playback, the number of times a viewer performs a skip operation is increased, and it is necessary to carry out fast forward and rewind operations, resulting in a problem of bad operability.

The present invention is useful in providing a video signal playback unit and a video signal playback method capable of skip playback with good operability, and with which it is easy for a viewer to determine whether or not a position skipped to is a desired skip position.

According to the first aspect of the present invention, a video signal playback unit, including a record and playback section for recording and playing back image data; a skip operation section for receiving skip playback instruction input resulting from user operation; a calculating section for calculating, based on the skip playback instruction input being input from the skip operation section, a first time skipped a predetermined time from a playback time at the time of input, and a second time obtained by adding a predetermined time to the first time; and an output section for outputting a first video signal for image data played back by the record and playback section, the first video signal being corresponding to the first time calculated by the calculating section, and a second video signal for image data played back by the record and playback section, the second image data being corresponding to the second time calculated by the calculating section.

The calculating section may calculate times a predetermined time before and after the first time.

The output section may output the first video signal made up of moving pictures, and output the second video signal made up of a still picture.

The unit may further include a selection operation section for receiving selection instruction input for selecting either of an output first video signal or an output second video signal output resulting from viewer operation, and wherein when a selection instruction input for selecting either video signal is received from the selection operation section within a predetermined time from the first time, the output section outputs the selected video signal.

When a selection instruction input for selecting either video signal is not received from the selection operation section within the predetermined time from the first time, the output section may output only the first video signal.

The calculating section may calculate a second time a predetermined time before or after the first time.

The output section may output the first video signal made up of moving pictures, and output the second video signal made up of a still picture.

The unit may further include a selection operation section for receiving selection instruction input for selecting either of an output first video signal or an output second video signal output resulting from viewer operation, and wherein when a selection instruction input for selecting either video signal is received from the selection operation section within a predetermined time from the first time, the output section outputs the selected video signal.

When a selection instruction input for selecting either video signal is not received from the selection operation section within the predetermined time from the first time, the output section may output only the first video signal.

When image data corresponding to the second skip time calculated by the calculating section is not recorded in the record and playback section, the output section may not output the second video signal.

According to the second aspect of the present invention, a video signal playback method, including: recording image data; receiving skip playback instruction input resulting from user operation; calculating, based on the skip playback instruction input being input, a first time skipped a predetermined time from a playback time at the time of input, and a second time obtained by adding a predetermined time to the first time; and playing back and outputting a first video signal for recorded image data, the first video signal being corresponding to the calculated first time, and a second video signal for recorded image data, the second video signal being corresponding to the calculated second time.

### BRIEF DESCRIPTION OF THE DRAWINGS

The invention will now be described by way of example with reference to the accompanying drawings, throughout which like parts are referred to by like references, and in which:

FIG. 1 is a diagram showing the structure of a video signal playback unit of an embodiment according to the present invention;

FIG. 2A to 2C are illustrates for showing a composite video signal of a first embodiment;

FIG. 3 is a flowchart explaining operation of the first embodiment from receipt of a skip playback instruction until display of a composite video signal;

FIG. 4 is a flowchart explaining operation of the first embodiment after display of a composite video signal;

FIG. 5 is a flowchart explaining operation of a second embodiment from receipt of a skip playback instruction until display of a composite video signal;

FIG. 6 is a flowchart explaining operation of the second embodiment after display of a composite video signal;

FIG. 7A to 7E are illustrates explaining operation of a third embodiment at the time of skip playback and at the time of back skip playback;

FIG. 8 is a flowchart explaining operation of a third embodiment from receipt of a skip playback or back skip playback instruction until display of a composite video signal;

FIG. 9 is a flowchart explaining operation of the third embodiment after display of a composite video signal;

FIG. 10A to 10D are illustrates showing a composite video signal output in a fourth embodiment;

FIG. 11 is a flowchart explaining operation of the fourth embodiment at the time of skip playback and at the time of back skip playback;

FIG. 12 is a flowchart explaining operation of a fifth embodiment of the present invention from receipt of a skip playback or back skip playback instruction until display of a composite video signal;

FIG. 13 is a flowchart explaining operation of the fourth embodiment of the present invention after display of a composite video signal.

### DESCRIPTION OF THE PREFERRED EMBODIMENTS

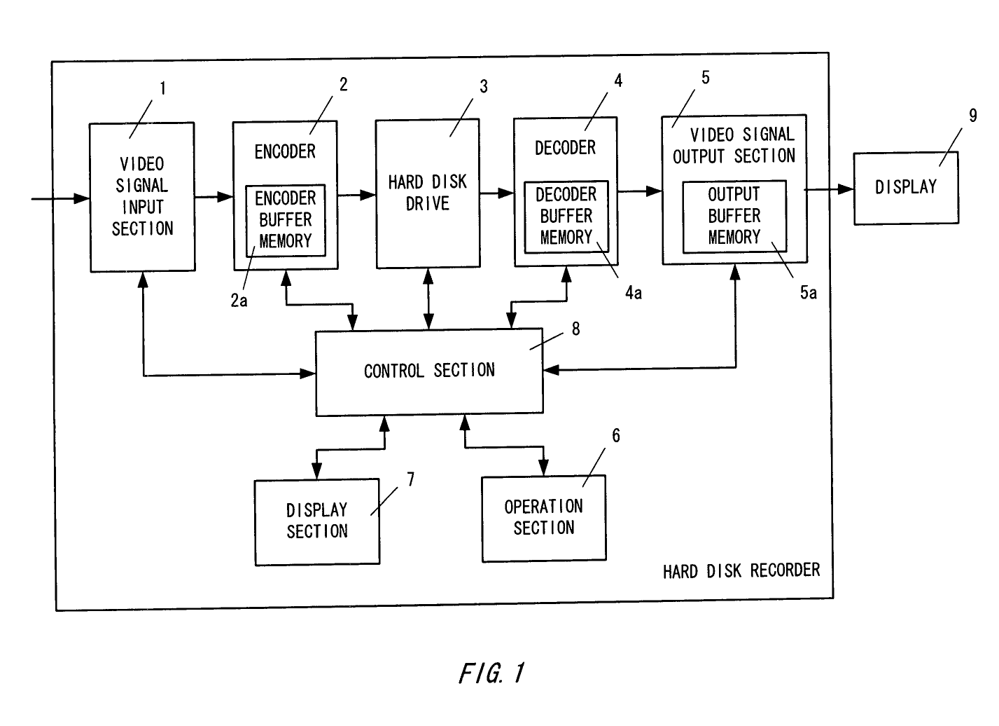

The following is a detailed description with reference to the drawings, of embodiments of the present invention. FIG. 1 shows the structure a video signal playback unit of an embodiment of the present invention.

In the embodiments shown below, description is given for examples where a hard disk recorder is a video signal playback unit, but this is not limiting, and the recorder may be also a video signal playback unit provided with a magneto-optical disk drive or a video signal playback unit provided with an IC memory drive.

In FIG. 1, the hard disc recorder is provided with a video signal input section 1, an encoder 2, a hard disc drive 3, a decoder 4, a video signal output section 5 and operation section 6 and a display section 7. A display 9 is connected to the video signal output section 5.

The video signal input section 1 receives a signal input from outside, and outputs the received video signal to the encoder 2. The video signal input section 1 has, for example, signal receiver for receiving a video signal output from an external playback device etc., a television tuner for receiving a television broadcast and outputting an image signal, or a network interface for receiving data transmitted via a network such as the internet and extracting and outputting a video signal from the received data. The video signal input section 1 is provided with an analog to digital converter (not shown), and in the case where the input signal is an analog signal, converts the analog signal to a digital signal and outputs a video signal.

The encoder 2 performs MPEG compression processing on a video signal output from the video input section 1, and outputs MPEG data to the hard disk drive 3. The encoder 2 is provided with encoder buffer memory 2a for storing MPEG data. The encoder 2 performs MPEG compression processing on a video signal input from the video input section 1, and stores compressed data in the encoder buffer memory 2a. If the amount of MPEG data stored in the encoder buffer memory 2a is a predetermined data amount, data is read out from the encoder buffer memory 2a for every predetermined data amount and output to the hard disc drive 3, under control of a control section 8, which will be described later.

Under control of the control section 8, described later, the hard disk drive 3 stores MPEG data output from the encoder, reads out the stored MPEG data and outputs the data to the decoder 4.

The decoder 4 performs MPEG expansion processing on the MPEG data output from the hard disk drive 3, and outputs the expanded video data to the video output section 5. The decoder 4 is provided with decoder buffer memory 4a for storing MPEG data input from the hard disk drive 3. The decoder 4 stores MPEG data input from the hard disk drive 3 in the decoder buffer memory 4a, and sequentially performs expansion processing on the stored MPEG data. An expanded video signal is sequentially output to the video signal output section 5 under control of the control section 8, described later.

The video signal output section 5 subjects the video signal output from the decoder 4 with NTSC demodulation processing to convert to an analog signal, and outputs a video signal to the connected display 9. The video signal output section 5 is provided with an output buffer memory 5a for temporarily storing the video signal that has been output from the decoder 4, subjected to NTSC demodulation processing, and converted to an analog signal. The video signal output section 5 may output video signals to a monitor provided in the video signal playback unit.

Under control of the control section 8, described later, at the time of normal playback the video signal output section 5 subjects the video signal output from the decoder 4 (a first video signal that will be described later) with NTSC demodulation processing to convert to an analog signal, and outputs the video signal to the connected display 9 without storing in the output buffer memory 5a.

Also, when an instruction signal for skip playback is input from the operation section 6, the video signal output section 5 demodulates the video signal output from the decoder 4 (second and third video signals that will be described later), and converts to analog signals. The video signal output section 5 temporarily stores this analog video signal in the output buffer memory 5a, and creates a composite video signal for simultaneous display of a video signal sequentially input from the decoder 5 (a first video signal that will be described later) and the video signal stored in the output buffer memory 5a. The composite video signal is output to the display 9. Preferably, the video output section 5 repetitively read out the second video signal and the third video signal stored in the output buffer memory 5a, described later, to display the second video signal and third video signal as a still image.

The composite video signal is a video signal for simultaneously displaying the first video signal, second video signal and third video signal, which will be described later. As one example, the first video signal is a moving picture or a still picture, and the second video signal and the third video signal are still pictures.

The operation section 6 outputs an instruction signal corresponding to an instruction input by a user from an operating button provided on the hard disk recorder or a remote control provided with buttons to the control section 8. As operating buttons there are provided buttons for playback/stop, fast forward/rewind, and skip playback, for example.

The display section 7 displays, for example, the operating state of the hard disk recorder, or when received an instruction from the operation section 6, the content of that instruction.

The control section 8 performs overall control of the entire unit, as described in detail below.

### First Embodiment

Control by the control section 8 of the first embodiment will be described in the following. In the first embodiment, when the control section 8 receives input of an instruction signal for skip playback from the operation section, the control section 9 calculates the time for a playback position (the first skip time), that is obtained by skipping a given skip time (in this embodiment it is set to 15 seconds, but this is not limiting and may be set to 30 seconds, for example) from the current playing back position of the video signal. The control section 8 also calculates the time (the second skip time) for the playback position of a predetermined time after the first skip time; and the time (the third skip time) for the playback position of a predetermined time before the first skip time. Specifically, the control section 8 calculates the second and third skip times by, for example, adding/subtracting a predetermined time to/from the calculated first skip time. In this embodiment, the predetermined time is 5 seconds, but this is not limiting.

Then, the control section 8 initially controls to read out from the hard disk drive 3 I frame data (second MPEG data) from MPEG data of one GOP (Group Of Pictures) containing a video signal for the third skip time to output to the decoder 4, to decode the second MPEG data in the decoder 4, and then to store the decoded third video signal in the output buffer 5a of the video output section 5.

Next, the control section 8 controls to read out from the hard disk drive 3 I frame data (second MPEG data) from MPEG data of one GOP containing a video signal for the second skip time to output to the decoder 4, to decode the second MPEG data in the decoder 4, and to store the decoded second video signal in the output buffer 5a of the video output section 5.

Finally, the control section 8 controls to read out from the hard disk drive 3 MPEG data continuing from MPEG data (first MPEG data) of one GOP containing a video signal for the first skip time to output to the decoder 4, to decode sequentially the first MPEG data in the decoder 4, and to output the decoded first video signal to the output buffer 5a of the video output section 5.

The control section 8 controls, if the first video signal output from the decoder 4 is input to the video signal output section, to create a composite video signal by combining the first video signal, the second video signal and the third video signal in the video signal output section 5, and to output the composite video signal to the display 9. In this embodiment the second video signal and the third video signal are I frame data of MPEG data, but this is not limiting as long as it is data for a video signal constituting one image.

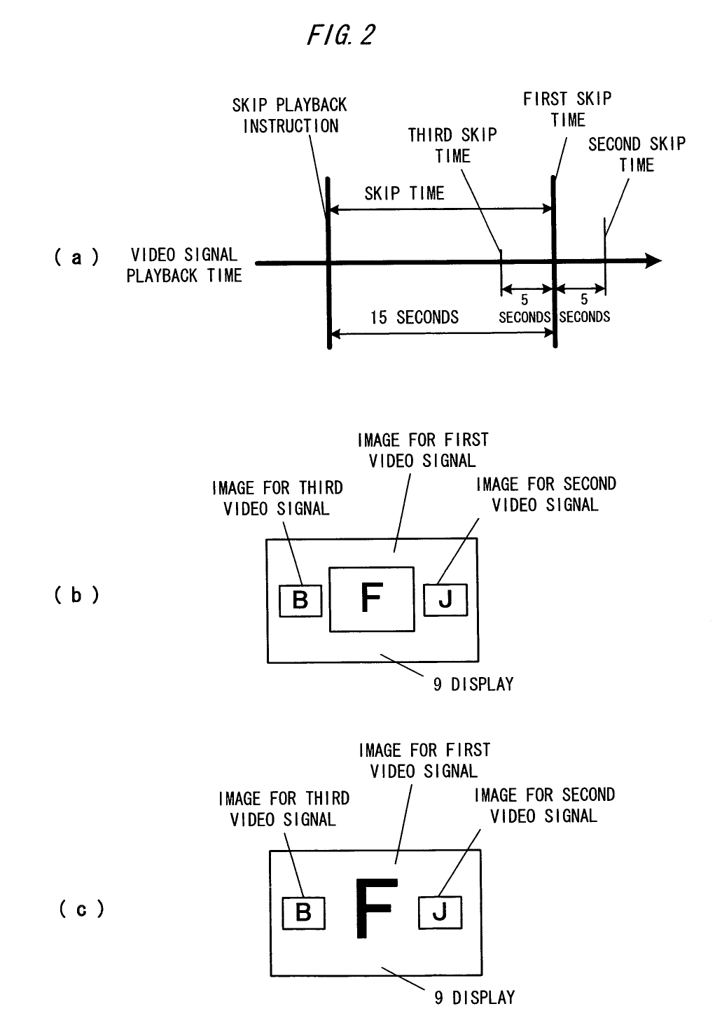

FIG. 2A to 2C are illustrates showing a composite video signal output from the hard disk recorder of this embodiment.

As shown in FIG. 2A, the composite video signal contains the first to the third video signals. The first video signal is a video signal for the time (the first skip time) of a playback position skipped for a skip time (15 seconds) from the playback time of a video signal where received a skip playback instruction. The second video signal is a video signal for the time (the second skip time) of a playback position that is a predetermined time (5 seconds) after the first skip time. The third video signal is a video signal (third video signal) for the time (the second skip time) of a playback position that is a predetermined time (5 seconds) before the first skip time. As a composite video signal, as shown in FIG. 2B, for example, the first video signal is displayed as a moving picture, and the second video signal and the third video signal are displayed as still pictures.

With this embodiment, within the display region of the display 9 the display region for the first video signal is large, while the display regions for the second video signal and the third video signal are small, but this is not limiting, and they may all be displayed in the same size regions. Also, as shown in FIG. 2C, the first video signal may be displayed in the entire display region of the display 9, and the second video signal and the third video signal may be displayed with overlapping on the first video signal.

The control section 8 controls the video signal output section 5 to output a video signal selected from the composite video signal being displayed to the display 9, when received an instruction signal input from the operation section 6 for selecting any video signal as well as an instruction signal for starting playback, until the playback time of the video signal passes a predetermined time (5 seconds) from the time of the playback position of the video signal as the skip point due to a skip playback operation.

As will be described later, the control section also controls to playback a first video signal for the skip point resulting from a skip playback operation, and if the first video signal after 5 seconds matches with the second video signal, controls the video signal output section 5 to switch from the composite video signal to the first video signal for outputting to the display 9.

In this way, the control section 8 controls the MPEG decoder to sequentially read out MPEG data from the hard disk drive, and controls to output the video signal from the video signal output section to the display 9.

Also, when the control section 8 received an input of an instruction signal for skip playback from the operation section 6, I frame data of MPEG data (second MPEG data and third MPEG data) for the times of a playback position that is a predetermined time after and before the time of the skip point (second skip time and third skip time) are read from the hard disk drive 3. A decoded signal is temporarily stored in the output buffer memory 5a of the video output section 5. Next, the control section 8 controls the video signal output section to continuously read out MPEG data and decode it, starting from first MPEG data from the hard disk drive 3, to output to the display 9 a composite video signal that is a combination of the first video signal, second video signal and third video signal from the video signal output section 5.

Next, operation of the hard disk recorder of the first embodiment will be described with reference to the drawings. In the following, description will be given for the case where a viewer inputs a skip playback operation using the operation section 6 during playback of a video signal.

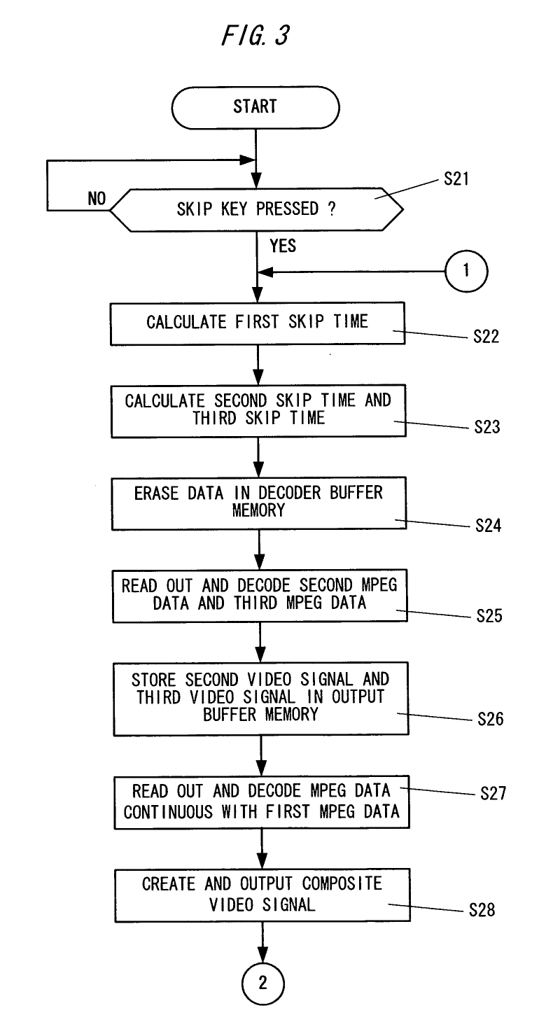

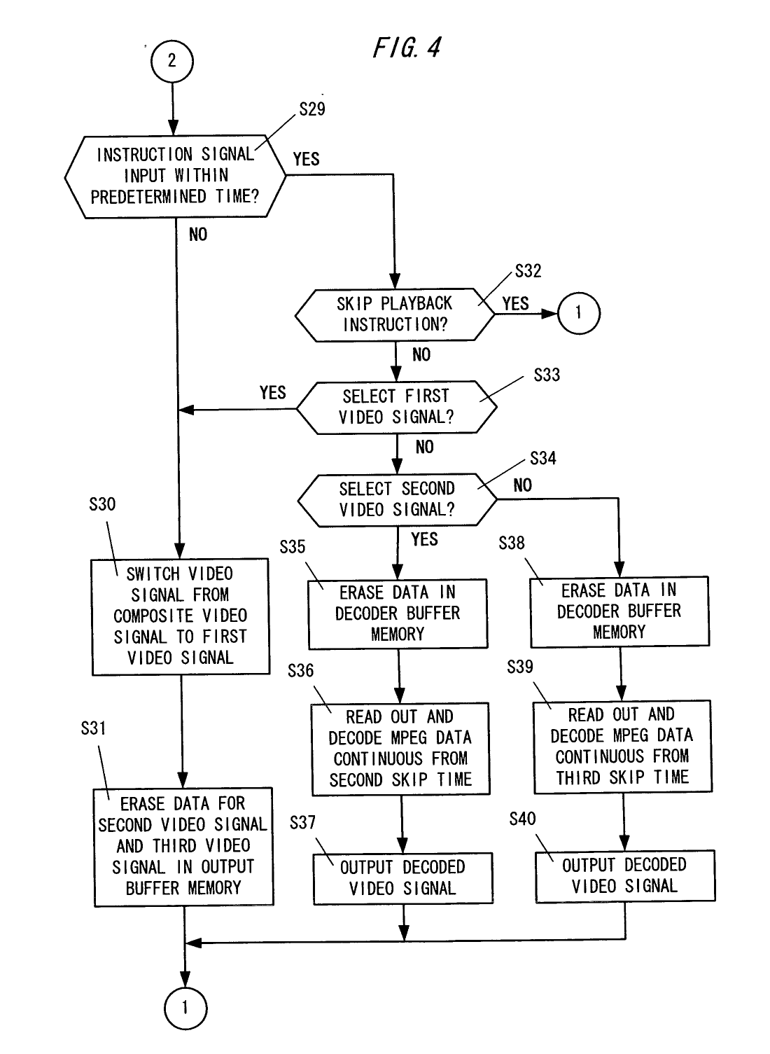

FIG. 3 is a flowchart explaining operation of the hard disk recorder of the first embodiment from receipt of a skip playback instruction until display of a composite video signal. FIG. 4 is a flowchart explaining operation of the hard disk recorder of the first embodiment after display of a composite video signal.

First of all, referring to FIG. 3, the control section 8 monitors for input of an instruction signal from the operation section 6. If the viewer inputs a skip playback instruction using the operation section 6, the operation section 6 outputs a skip playback instruction signal to the control section 8.

The control section 8 calculates the time (the first skip time) of a playback position, that is a skip point skipped a skip time from the time of a playback position for a video signal being played back when a skip playback instruction signal is input from the operation section 6 (step S22). Once the control section 8 calculates the first skip time, the second skip time and the third skip time are calculated based on the first skip time (step S23).

The control section 8 deletes data stored in the buffer memory 4a of the decoder 4 (step S24).

The control section 8 reads out second MPEG data and third MPEG data from MPEG data stored in the hard disk drive 3 based on the second skip time and the third skip time, and controls to decode the data in the decoder 4 (step S25).

The second video signal and the third video signal decoded by the decoder 4 are temporarily stored in the output buffer memory 5a of the video output section 5 (step S26).

Then, the control section 8 reads out MPEG data continuous to MPEG data for one GOP containing the first skip time from MPEG data stored in the hard disk drive 3 based on the first skip time, and controls to decode the data in the decoder 4 (step S27).

The first video signal decoded by the decoder 4 is combined with the second video signal and the third video signal by the video output section 5 and output to the display 9 (step S28).

As a result of the following operation, as shown in FIG. 2B and FIG. 2C, an image (moving image) for the skip point, an image (still image) for the time of the playback position that is a predetermined time before the skip point time, and an image (still image) for the time of the playback position a predetermined time after the skip point time are simultaneously displayed on the display 9. Owing to these images, it is easy for the viewer to determine whether or not the position of the skip point is the desired skip position.

Next, the control section 8 monitors for whether or not an instruction signal is input from the operation section 6, after starting playback of the first video signal (moving picture), also after a predetermined time (for example 5 seconds) from the playback time of the first video signal, and until the playback time of the first video signal reaches the second skip time (FIG. 4, step S29). At this time, operation by the viewer is either of a skip playback instruction, a start playback instruction, a start playback from second skip time instruction, and a start playback from third skip time instruction. Based on the viewer's instruction the operation section 6 outputs an instruction signal corresponding to the input instruction to the control section 8.

When no instruction signal is input from the operation section 6, after starting playback of the first video signal (moving picture), after a predetermined time (for example 5 seconds) from the playback time of the first video signal, and until the playback time of the first video signal reaches the second skip time (NO in step S29), the control section 8 controls the video signal output section 5 to switch the video signal output to the display 9 from the composite video signal to the first video signal that is read out from the hard disk drive 3 continuously from the first skip time and decoded, to output to the display 9.

That is, after starting playback of the first video signal, until the playback time of the first video signal reaches the second skip time and there input no instruction signal from the operation section 6, the first video signal being played back as a moving picture will be the same as the second video signal a predetermined period of time (5 seconds) from start of playback. If the skip key has not been pressed down by the user up to this time point, not the composite signal but the first video signal being played back as a moving picture is output from the video output section 5 to the display 9.

After switching from the video signal output section to the first video signal for outputting, the control section 8 discards the unnecessary second video signal and third video signal stored in the output buffer memory of the video signal output section 5 (step S31). After that, the control section 8 returns processing thereof to step S21 and monitors whether or not the skip key of the operation section 6 is pressed down.

During the time period from commencement of playback of the first video signal until a predetermined time has elapsed and the second skip time reached, if input of a skip playback instruction is received from the operation section (YES in step S29) and the instruction signal is an instruction (skip playback instruction) (YES in step S32), the control section 8 returns processing thereof to step S22 to calculate the first to third skip times.

Also, in the case where there received instruction signal input from the operation section 6 (YES in step S29) and the instruction signal is not a skip playback instruction (NO in step S32), the control section 8 determines whether or not the instruction signal is an instruction to select the first video signal (step S33).

When the instruction signal is an instruction to select the first video signal (YES in step S33), the control section 8 switches from the composite video signal to the first video signal to output the first video signal from the video output section 5 to the display 9 (step S30). Next, the control section 8 discards data for the second video signal and third video signal in the output buffer memory 5a (step S31), and proceeds processing thereof to step S22.

If the instruction signal is not an instruction to select the first video signal or to start playback (NO in step S33), and there is input an instruction to select the second video signal (step S34), data in the decoder buffer memory 4a of the decoder 4 is discarded (step S35), and MPEG data continuing from the second skip time is read from the hard disk drive 3 and decoded (step S36). Next, the control section 8 carries out control to output the decoded video signal to the display 9 from the video signal output section 5 (step S37). After that, processing transfers to step S22.

If the instruction signal is not an instruction to select the second video signal (NO in step S34), the control section 8 determines that the instruction signal is an instruction to select the third video signal and commences playback. In this case, the control section deletes data in the decoder buffer memory 4a of the decoder 4 is discarded (step S38), MPEG data continuing from the third skip time is read from the hard disk drive 3 and decoded (step S39), and the decoded video signal is output from the video signal output section to the display 9 (step S40). Processing then transfers to step S22.

As a result of the above described processing, in the hard disk recorder, when the skip key has been pressed down, a first video signal at a point that has been skipped for the skip time is displayed as a moving picture, and the second video signal for a second skip time and the third video signal for a third skip time are displayed together with the first video signal as still pictures.

In this way, it is possible for the viewer to simultaneously see an image at a point that has been skipped for the skip time as a result of skip playback and images at playback times that are a predetermined time before and after the image at the skipped time point. It is therefore possible to easily determine whether or not the time point skipped from the skip point is the desired skip point based on the displayed images. It is also possible to easily determine whether or not the skipped time point is close to the desired skip point, by watching the image at the skip point, and the images that are a predetermined time before/after the image at the skip point.

Further, if the skip key is pressed down again when displaying the images for a predetermined time before and after the skip point, that is, within a predetermined time from the skip point, new (further) skipping is performed from the time of playing back the first video signal (moving picture). If the playback start key is pressed, it is also possible for the viewer to continue watching the first video signal displayed on the display 9 from that time point. Further, if an instruction to select the second video signal or the third video signal is input when displaying the images a predetermined time before and after the image at the skip point, playback of the video signal commences from the selected second video signal or third video signal, and a still picture is displayed on the display 9.

With the above described first embodiment, when there is input a skip playback instruction, the first video signal is played back as a moving picture, and the second video signal and third video signal are played back as still pictures. However, it may be played back all of the first video signal, the second video signal and the third video signal as still pictures to display on the display 9.

### Second Embodiment

Operation of a hard disk recorder of a second embodiment of the present invention will be described in the following. With the hard disk recorder of the second embodiment, when an instruction for skip playback is received from the operation section 6, the first video signal, second video signal and third video signal are all displayed on the display 9 as still images. In order to facilitate understanding, description of operations that are the same as in the first embodiment described above will be omitted.

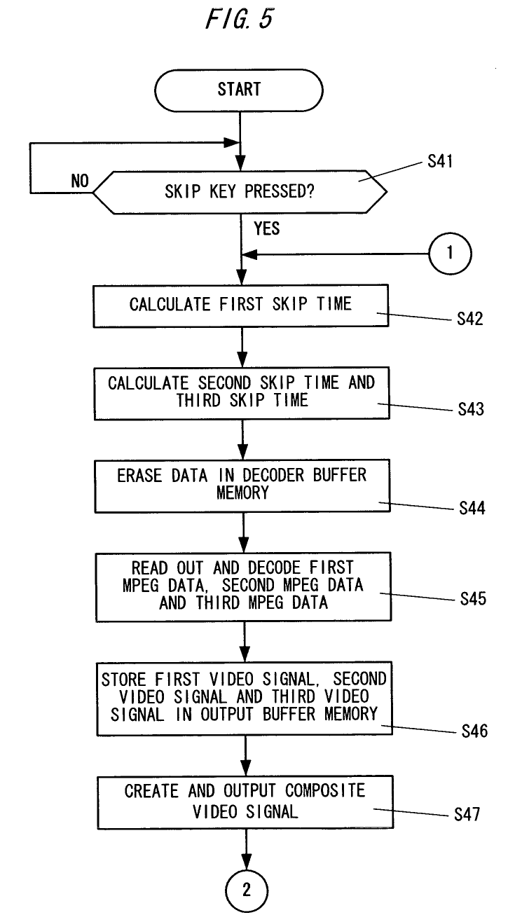

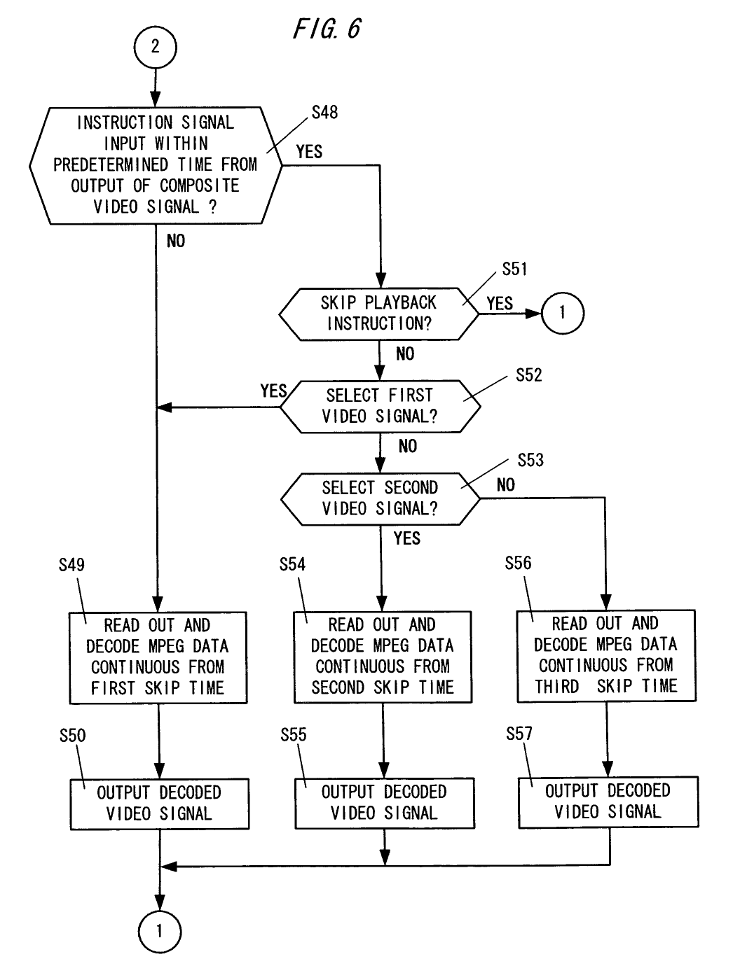

FIG. 5 is a flowchart showing operation of a video playback unit according to the second embodiment of the present invention, from receipt of a skip playback instruction until display of a composite video signal. FIG. 6 is a flowchart showing operation of a video playback unit according to the second embodiment of the present invention, after display of a composite video signal.

First of all, the control section 8 monitors for inputting of an instruction signal from the operation section 6 (step S41 in FIG. 5). If the viewer inputs a skip playback instruction using the operation section 6, the operation section 6 sends a skip playback instruction signal to the control section 8.

The control section 8 calculates a time (first skip time) of a playback position that has been skipped for a predetermined time, based on the playback time of a video signal when a skip playback instruction was input (step S42). Once the control section 8 calculates the first skip time, the second skip time and the third skip time are calculated based on the first skip time (step S43).

Next, the control section 8 discards data stored in the buffer memory 4a of the decoder 4 (step S44).

The control section 8 reads out first to third MPEG data for one GOP respectively corresponding to first to third skip times among MPEG data stored in the hard disk drive 3 based on the first skip time, the second skip time and the third skip time, and makes the data to be decoded in the decoder 4 (step S45).

A decoded first video signal, second video signal and third video signal are sent to the video signal output section 5, and stored in the output buffer memory 5a (step S46).

The video output section 5 creates a composite video signal from the first video signal, second video signal and third video signal stored in the output buffer memory 5a, and outputs the composite video signal to the display 9 (step S47). The first video signal, second video signal and third video signal are respectively displayed on the display 9 as still pictures.

Next, the control section 8 monitors whether or not there is input an instruction signal from the operation section 6, within a predetermined time from the time the composite signal is displayed, using a timer not shown (step S48 in FIG. 6). At this time, the viewer can input a skip playback instruction, a start playback instruction (instruction to commence playback from the first skip time), an instruction to start playback from second skip time, or an instruction to start playback from third skip time. The operation section 6 outputs an instruction signal corresponding to the input instruction to the control section 8.

If there is input no instruction signal from the operation section 6 within a predetermined time from the time of displaying the composite signal (NO in step S48), the control section 8 reads and decodes MPEG data consecutive from the first skip time, from the hard disk drive 3 (step S49). A decoded signal is output from the video output section 5 to the display 9 (step S50). In this way, an image from the time of the skip point (first skip time) is displayed on the display 9 as a moving picture. After that, processing transfers to step S41, and the control section 8 monitors whether or not the skip key has been pressed down from the operation section 6.

In the case where an instruction signal input is received from the operation section 6 (YES in step S48) within a predetermined time from the time when the composite signal is displayed and the instruction signal is a skip playback instruction (YES in step S51), the control section 8 carries out the processing after step S42 (FIG. 5).

If the instruction signal is not a skip playback instruction (NO in step S51), it is determined whether or not the instruction signal is an instruction to select the first video signal (step S52). If the instruction signal is an instruction to select and play back the first video signal (YES in step S52), MPEG data consecutive from the first skip time is read from the hard disk drive 3 and decoded (step S49). A decoded video signal is output from the video output section 5 to the display 9 (step S50), and processing after that transfers to step S42 (FIG. 5).

If the instruction signal is an instruction to select and play back the second video signal (YES in step S53, FIG. 6), MPEG data consecutive from the second skip time is read from the hard disk drive 3 and decoded (step S54). A decoded video signal is output from the video output section 5 to the display 9 (step S55). After that, processing transfers to step S42 of FIG. 5.

If the instruction signal is not a select instruction for the second video signal (NO in step S53, FIG. 6), the control section 8 determines that the instruction is an instruction to select the third video signal, and MPEG data consecutive from the third skip time is read from the hard disk drive 3 and decoded (step S56). A decoded video signal is output from the video output section 5 to the display 9 (step S57). After that, processing transfers to step S42 in FIG. 5.

As a result of the above described processing, in the hard disk recorder, when a skip instruction has been input, a first video signal corresponding to the first skip time of the skip point, and the second and third video signals respectively corresponding to the second and third skip times a predetermined time before and after the first skip time, are displayed as still pictures.

In this way, it is possible for the viewer to simultaneously see an image for a time point that has been skipped for the skip time as a result of skip playback and images a predetermined times before and after at the skipped point. It is therefore possible to easily determine whether or not the point skipped from the skip point is a desired skip point, based on the image at the skipped point. It is also possible to easily determine whether or not the skipped time point is close to the desired skip point, based on the image at the skip point, the image that is a predetermined time before the image at the skip point, and/or the image that is a predetermined time after the image at the skip point.

Further, at the time when the image at the skip point is displayed, it is possible for the user to skip for a additional skip time from the first skip time by pressing down the skip key again. Also, if the user presses the playback start key, the first video signal is displayed on the display 9 from that time point. Further, if an instruction for selecting the second video signal or the third video signal is input when displaying the images for a predetermined time before and after the image at the skip point, playback of the video signal commences from the selected second video signal or third video signal for the still image, and a moving picture is displayed on the display.

In the above described first and second embodiments, if a skip playback operation is carried out, a composite video signal formed from the first video signal, the second video signal and the third video signal is displayed on the display. However, it is also possible, as a result of setting carried out by the viewer using the operation section 6, to select either normal skip playback, that is, skip playback for automatically playing back a video signal at the skip point, or the above described skip playback.

Also, in the above described first and second embodiments, single respective times (the second and the third skip times) are calculated for before and after the skip point time (the first skip time), and images for three times are displayed simultaneously. However, it is also possible to calculate a plurality of times before and after the skip point time, and to simultaneously display images for each time. For example, it is possible to display images 3 for seconds before, 5 seconds before, three seconds after and 5 seconds after the skip point time.

Also, the above-described first and second embodiments have been described for the case of skipping to a skip time with respect to the current playback time of a video signal. However, it is also possible, when skipping to a time returned from the current playback time (“back skip”), to display images for a playback time a predetermined time before and a predetermined time after the back skip point.

### Third Embodiment

Next, description will be given of a third example of operation of the hard disk recorder of the embodiment according to the present invention.

In the above described first and second embodiments, when a skip instruction is input, images both a predetermined time before and after the skip point are displayed, but this is not limiting. Specifically, when a skip instruction is input, it is possible to display only one image for a predetermined time either before or after the skip point image.

As the third example of the present invention, description will be given for the case where, when a skip playback or back skip playback instruction is input, only one image for either a predetermined time before or a predetermined time after the skip point of the back skip point time is displayed. In order to facilitate understanding, description of structures that are the same as in FIG. 1 to FIG. 6 will be omitted.

When an instruction signal for skip playback or back skip playback is input from the operation section 6, the video signal output section 5 performs NTSC type demodulation processing on a video signal output from the decoder 4 (a second video signal that will be described later), and converts to an analog signal. A decoded signal is temporarily stored in the output buffer memory 5a. The video signal output section 5 creates a composite video signal for allowing simultaneous display of a video signal sequentially input from the decoder 5 (a first video signal that will be described later) and a video signal stored in the output buffer memory 5a. Note that, the video output section 5 controls to display the second video signal as a still image, which will be described later, and the second video signal stored in the output buffer memory 5a is preferably repeatedly read out.

The composite video signal is output from the video signal output section 5, and the first video signal and the second video signal, which will be described later, are simultaneously displayed on a screen of the display 9. For example, the first video signal is a moving picture or a still picture, and the second video signal is a still picture.

In the third example, when an instruction signal for skip playback or back skip playback is input from the operation section 6, the control section 8 calculates a playback time (first skip time or first back skip time) skipped a predetermined time before or after the current playback time of the video signal. Here, in the case where there is input a skip playback instruction, a time (the second skip time) for a playback point that is a predetermined time after the first skip time is calculated. Here, in the case where there is input a back skip playback instruction, a time (the second back skip time) for a playback point that is a predetermined time before the first skip time is calculated. In this embodiment, the skip time is 5 seconds, but it is not limited to 15 seconds and can be 30 second etc. Also in this embodiment, the predetermined time is 5 seconds, but this is not limiting.

Specifically, when input of an instruction signal for skip playback is received from the operation section 6, the control section 8 calculates a first skip time (FS1) for a playback position skipped for the skip time before the current playback time of the video signal, and calculates a second skip time (FS2) for a playback time a predetermined time after the first skip time (FS1). Also, when there is input an instruction signal for back skip playback from the operation section 6, the control section 8 calculates a first back skip time (BS1) for a playback time skipped for a predetermined skip time after the current playback position of the video signal, and calculates a second back skip time (BS2) for a playback time a predetermined time before the first back skip time (BS1).

Then, the control section 8 initially carries out control so that I frame data (second MPEG data) from MPEG data of one GOP (Group Of Pictures) containing a video signal for the second skip time (FS2) or the second back skip time (BS2) is read from the hard disk drive 3 and output to the decoder 4. The second MPEG data is decoded by the decoder 4, and the decoded second video signal is stored in the output buffer memory 5a of the video output section 5.

Finally, the control section 8 carries out control so that MPEG data continuing from MPEG data (first MPEG data) of one GOP containing a video signal for the first skip time (FS1) or the first back skip time (BS1) is read from the hard disk drive 3 and output to the decoder 4, the first MPEG data is sequentially decoded in the decoder 4, and the decoded first video signal is output to the output buffer 5a of the video output section 5.

The control section 8 performs control so that if the first video signal output from the decoder 4 is input to the video signal output section, a composite video signal is created by combining the first video signal and the second video signal in the video signal output section 5, and the composite video signal is output to the display 9. In this embodiment the second video signal is made I frame data of MPEG data, but this is not limiting as long as it is data for a video signal constituting one image.

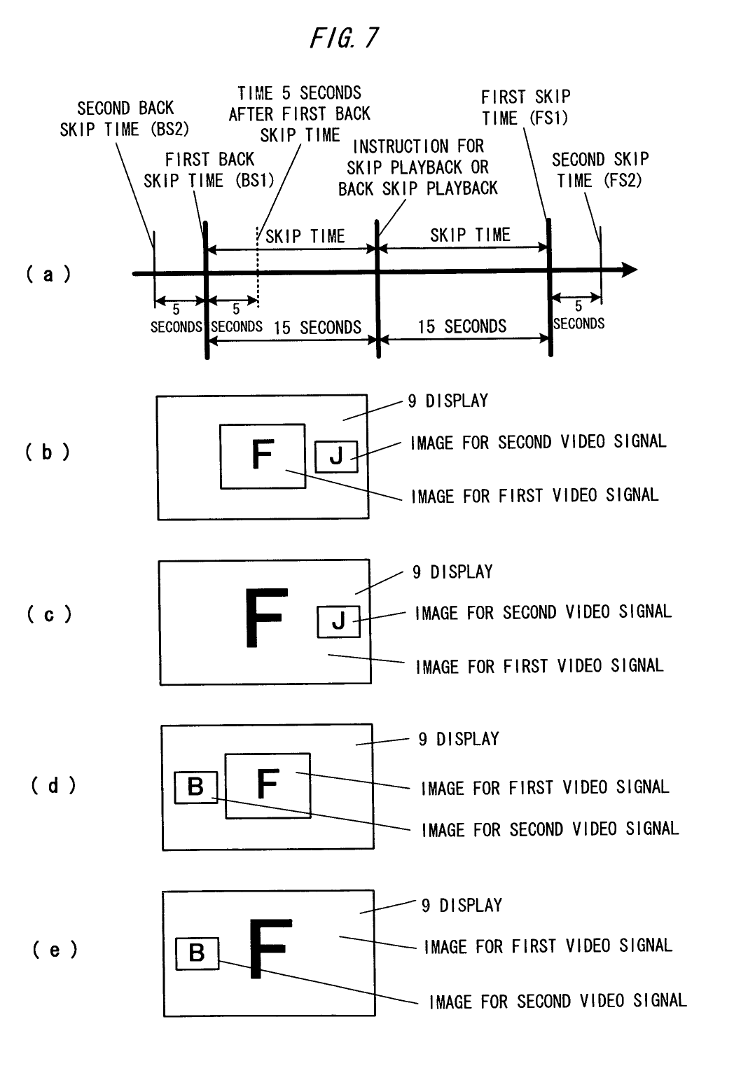

FIG. 7A to 7E are illustrations for showing operation of a video signal playback unit of this embodiment at the time of skip playback or at the time of back skip playback.

The composite video signal consists of a first video signal and second video signal. The first video signal is a video signal corresponding to a first skip time (FS1) or a first back skip time (BS1) that has been skipped for a predetermined skip time (15 seconds) from a time point where an instruction for a skip playback or back skip playback is input, as shown in FIG. 7A. Also, the second video signal is a video signal corresponding to a second skip time FS2 that is a predetermined time (5 seconds) after the first skip time (FS1) if a skip playback instruction is input, or is a video signal corresponding to a second back skip playback time (BS2) a predetermined time (5 seconds) before the first back skip time (BS1) if a back skip playback instruction is input. If a composite video signal is output to the display 9, as shown in FIG. 7B or 7D, the first video signal is displayed as a moving picture, and the second video signal is displayed as a still picture.

With this embodiment, within the display region on the display 9, the display region for the first video signal is large, while the display region for the second video signal is small, but this is not limiting, and they may be displayed in regions of same size. Also, as shown in FIG. 7C or 7E, it is possible to display the first video signal within the entire display region on the display 9, and to display the second video signal overlapping with the first video signal.

The control section 8 carries out control so that when an instruction to select a separate video signal is input from the operation section 6 within a predetermined time (5 seconds) from the playback time of the video signal at the skip point, the video signal output section 5 switches from the composite video signal to the selected video signal and outputs to the display 9.

The control section 8 also carries out control so that, as will be described later, the first video signal for the skip point resulting from a skip playback operation is played back, and if the first video signal after 5 seconds matches the second video signal, the video signal output section 5 switches from the composite video signal to the first video signal and outputs to the display 9.

The control section 8 also carries out control so that, as will be described later, the first video signal for the back skip point is played back, and at a predetermined time from the first back skip time video signal output section 5 switches from the composite video signal to the first video signal and outputs to the display 9.

In this way, the control section 8 carries out control so that MPEG data sequentially read out from the hard disk drive is decoded by the MPEG decoder, and a video signal is output from the video signal output section to the display 9.

Also, when the control section 8 has received input of an instruction signal for skip playback or back skip playback from the operation section 6, the decoder 4 is controlled so that I frame data of MPEG data (second MPEG data) for a second skip time (FS2) that is a predetermined time after the first skip time (FS1), or second back skip time (BS2) that is a predetermined time before the first back skip tome (BS1) are read from the hard disk drive 3, and decoded by the decoder 4. A decoded signal is temporarily stored in the output buffer memory 5a of the video output section 5. Further, the control section 8 controls the decoder 4 so as to read and decode MPEG data continuing from the MPEG data from the hard disk drive 3. Next, the control section 8 carries out control so that a composite signal that is a combination of the first video signal and the second video signal is output from the video signal output section.

Next, operation of a video signal playback unit of a third embodiment will be described. In the following, description will be given for the case where a viewer inputs a skip playback or back skip playback operation using the operation section 6 during playback of a video signal. In order to facilitate understanding, description of structures that are the same as in FIG. 1 to FIG. 7 will be omitted.

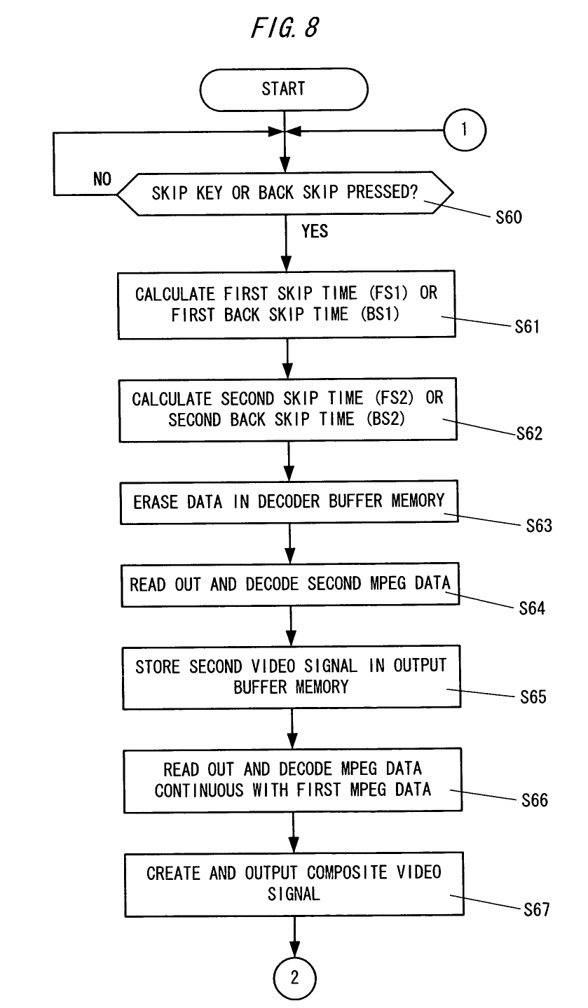

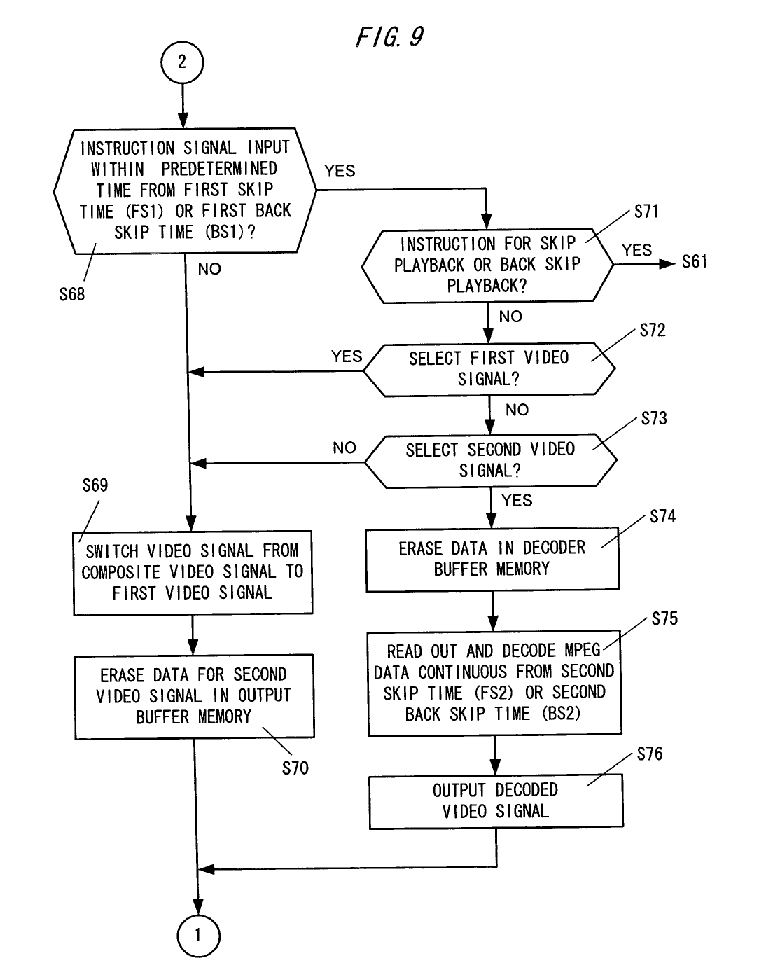

FIG. 8 is a flowchart showing operation of a third embodiment from receipt of a skip playback or back skip playback instruction until display of a composite video signal. FIG. 9 is a flowchart showing operation of the third embodiment after display of a composite video signal.

First of all, the control section 8 monitors for input of an instruction signal from the operation section 6 (step S60 in FIG. 8). If the viewer inputs an instruction for skip playback using the operation section 6, the operation section 6 outputs a skip playback instruction signal to the control section 8. If an instruction for back skip playback is received, the operation section 6 outputs a back skip playback instruction signal to the control section 8.

The control section 8 calculates a first time (FS1) or a first back skip time (BS1) skipped a predetermined skip time from the playback time when an instruction signal for skip playback or back skip playback is input from the operation section 6 (step S61). Once the control section 8 calculates the first skip time (FS1) or the first back skip time (BS1), the second skip time (FS1) or the second back skip time (BS2) is calculated based on the first skip time (FS1) or the second back skip time (BS1) (step S62).

The control section 8 discards data stored in the buffer memory 4a of the decoder 4 (step S63).

The control section 8 reads out second MPEG data among MPEG data stored in the hard disk drive 3 based on the second skip time (FS2) or the second back skip time (BS2), and makes the data to be decoded in the decoder 4 (step S64).

The second video signal decoded by the decoder 4 is stored in the output buffer memory 5a of the video output section 5 (step S65).

The control section 8 reads out MPEG data continuous to MPEG data for one GOP corresponding to the first skip time (FS1 or the first back skip time (BS1) among MPEG data stored in the hard disk drive 3, and makes the data to be decoded in the decoder 4 (step S66).

The first video signal decoded by the decoder 4 is combined with the second video signal by the video output section 5 and output to the display 9 (step S67).

As a result of the above described operation, as shown in FIG. 7B to FIG. 7D, an image (moving image) for the skip point and an image (still image) for a predetermined time after the skip point time, or an image (moving image) for the back skip point and an image (still image) for a predetermined time before the back skip time are simultaneously displayed on the display 9. As a result of this image display, it is easy for the viewer to determine whether or not the skipped time point is the desired skip position.

After that, after commencing skip playback or back skip playback, the control section 8 monitors whether or not there is input an instruction from the operation section within a predetermined time (for example, 5 seconds) from the first skip time (FS1) or the first back skip time (BS1) (Step S68 in FIG. 9). At this time, the user can input a skip playback instruction or a back skip playback instruction, and instruction for starting playback from the second skip time. Based on the viewer's operation, the operation section 6 outputs an instruction signal corresponding to the input instruction to the control section 8.

When no instruction signal is input from the operation section 6, within a predetermined time (for example 5 seconds) from the playback time of the first video signal (NO in step S68), the control section 8 controls the video signal output section 5 so as to switch from the composite video signal to the first video signal read out from the hard disk drive 3 continuously from the first skip time (FS1) or the first back skip time (BS1) and decoded, and output to the display.

If the viewer has not pressed the skip key up to this time point, the control section 8 carries out control so that only the first moving picture video signal is output from the video output section 5 to the display 9.

After switching to outputting only the first video signal, the control section 8 erases unnecessary second video signal data stored in the output buffer memory 5a of the video signal output section 5. After that, the control section 8 monitors whether or not the skip key or the back skip key of the operation section 6 has been pressed down (step S60).

If there is input an instruction signal from the operation section within a predetermined time from the first skip time (FS1) or the first back skip time (BS1) (YES in step S68), and that instruction signal is an instruction for skip playback (when the skip key has been pressed) or an instruction for back skip playback (when the back skip key has been pressed) (YES in step S71), the control section 8 carries out processing after step S61 in FIG. 8.

Also, if the instruction signal is not a skip playback instruction or a back skip playback instruction (NO in step S71 in FIG. 9), the control section 8 determines whether or not the instruction signal is an instruction to select the first video signal (step S72).

When the instruction signal is an instruction to select the first video signal (YES in step S72), the control section 8 carries out control so that the video output section 5 is switched from the composite video signal to the first video signal and the first video signal is output to the display 9 (step S69). Also, the control section 8 erases data for the second video signal and third video signal in the output buffer memory 5a (step S70), and proceeds the processing from step S60 onwards in FIG. 8.

If the instruction signal is not an instruction to select the first video signal (NO in step S72), and there is input an instruction to select the second video signal (YES in step S73), data in the decoder buffer memory 4a of the decoder 4 is erased (step S74), and MPEG data continuing from the second skip time (FS2) or the second back skip time (BS2) is read from the hard disk drive 3 and decoded (step S75). A decoded video signal is output from the video output section 5 to the display 9 (step S76) Processing then proceeds to step S60 onwards.

As a result of the above described processing, with the third embodiment, when a viewer presses the skip key or back skip key, the first video signal for the skip point time is displayed on the display 9 as a moving picture at the same time as the second video signal for the second skip time or the second back skip time is displayed as a still picture.

By doing this, in skip playback it is possible for the viewer to simultaneously see an image for the skip point and an image a predetermined time after the skip point. Also, in back skip playback it is possible for the viewer to simultaneously see an image for the back skip point and an image a predetermined time before the back skip point. It is therefore possible to easily determine whether or not the image at the skip point is the desired image based on the image for the skip point or back skip point. It is also possible to easily determine either a skip point or a predetermined time after the skip point is close to a desired skip point, and whether or not either of the back skip point or the time point that is a predetermined time before the back skip point is closer to the desired skip point. It is also possible based on this for the viewer to easily determine whether or not another skipping is required.

If the viewer then presses the skip key again while an image for a predetermined time after the skip point or a predetermined time before the back skip point is being displayed, an additional skip time from the time point (first skip time or first back skip time) where playback of the first video signal (moving picture) commences is skipped. With this example, when the skip key is pressed again, the next skip position is calculated from the first skip time or the first back skip time, but it is also possible to calculate the next skip position from the point being played back, instead of from the first skip time or first back skip time.

Also, if the viewer presses the start playback key, it may also be display only the first video signal on the display 9 from that time point, thereby allowing the viewer to continue viewing. Further, if there is input an instruction to select the second video signal when displaying an images for a predetermined time after the skip time or an image for a predetermined time before back skip time, playback of the video signal commences from the selected second video signal, and a moving picture is displayed on the display 9.

### Fourth Embodiment

In the following, description will be given for operation in the case where, when a skip playback or back skip playback instruction is newly input while playing back, a time that is a predetermined time before or after the time of a skip point or a back skip point time is later than the completion time or earlier than the start time for the video signal being played back.

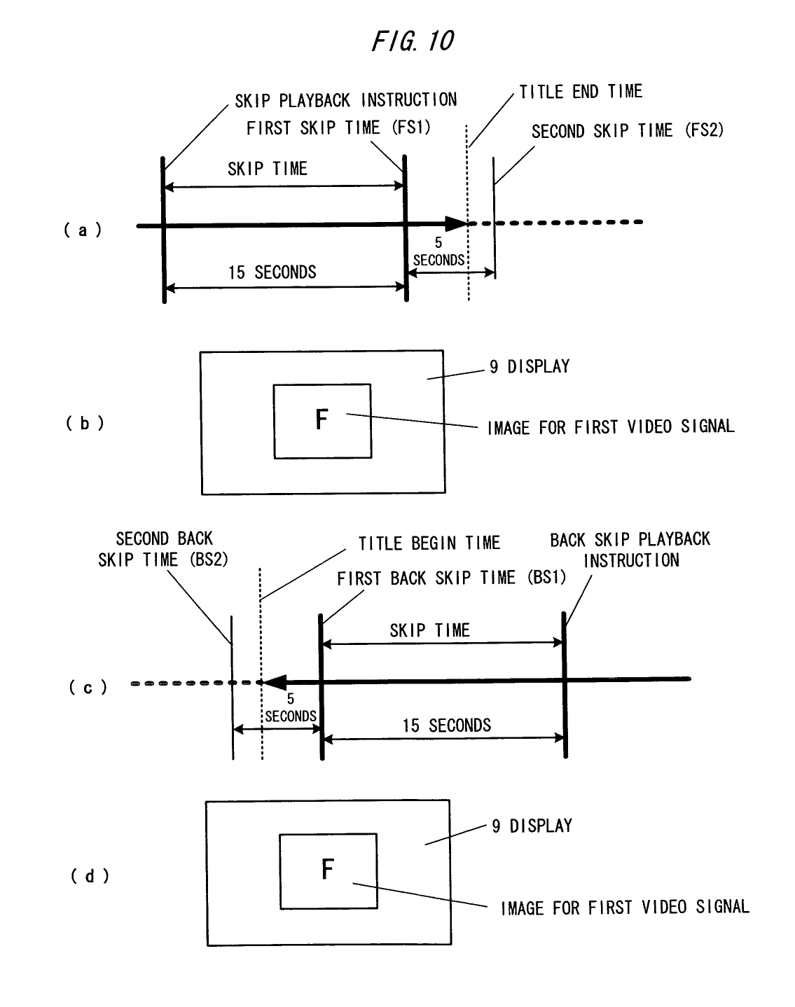

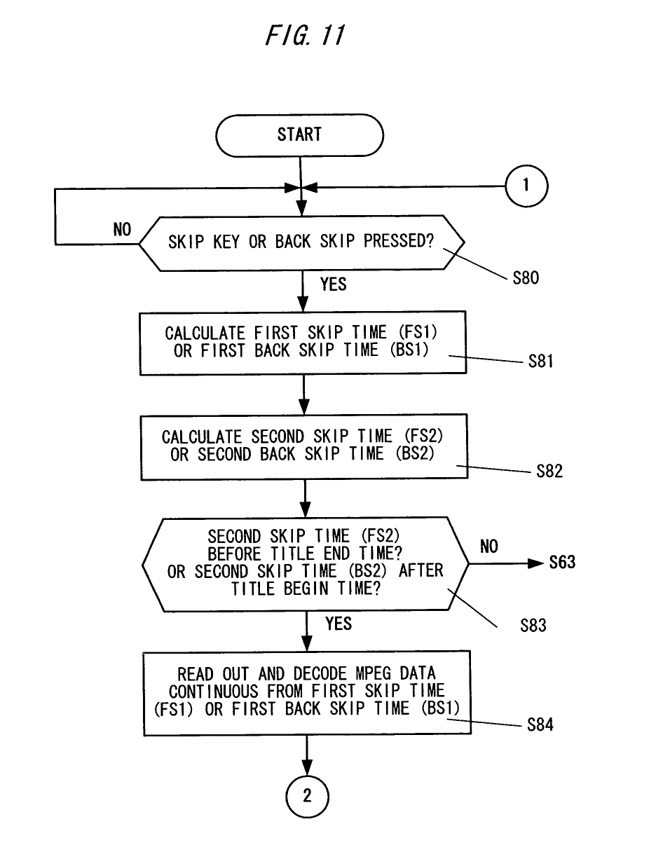

FIG. 10A to 10D are illustrations for describing a composite video signal output in a fourth embodiment. FIG. 11 is a flowchart showing operation of the fourth embodiment at the time of skip playback and at the time of back skip playback. In order to facilitate understanding, description of structures that are the same as in the first to third embodiments described above will be omitted.

As shown in FIG. 10A and FIG. 10B, when there is input no video signal corresponding to a predetermined time (for example, 5 seconds) after the time (first skip time (FS1)) of the skip point calculated at the time of skip playback, only a video signal (first video signal) corresponding to the first skip time is displayed. As shown in FIG. 5C and FIG. 5D, when there is input no video signal corresponding to a predetermined time (for example, 5 seconds) before the time (first back skip time (BS1)) of the skip point calculated at the time of back skip playback, only a video signal (first video signal) corresponding to the first back skip time is displayed.

Operation of a hard disk recorder of the fourth embodiment will be described in the following with reference to FIG. 11. First of all, the control section 8 monitors for presence or absence of an instruction signal from the operation section 6 (step S80). If the viewer inputs an instruction for skip playback or back skip playback from the operation section 6, the operation section 6 outputs a skip playback or back skip instruction signal to the control section 8.

The control section 8 calculates a first time (FS1) or a first back skip time (BS1) skipped a predetermined skip time from the playback time of a video signal being played back when an instruction signal for skip playback or back skip playback is input from the operation section 6 (step S81). Once the control section 8 calculates the first skip time (FS1) or the first back skip time (BS1), the second skip time (FS1) or the second back skip time (BS2) is calculated based on the first skip time (FS1) or the second back skip time (BS1) (step S82).

The control section 8 then determines as to whether the calculated second skip time (FS2) is before the completion time (title end time) for the video signal being played back, and whether the calculated second back skip time (BS2) is after the start time (title begin time) for the video signal being played back (step S83).

Here, when the calculated second skip time (FS2) is before the completion time (title end time) for the video signal being played back, and the calculated second back skip time (BS2) is after the start time (title begin time) for the video signal being played back (NO in step S83), the control section 8 carries out processing from step S63 to step S67 in FIG. 8.

Here, when the second skip time (FS2) is after the completion time (title end time) for the video signal being played back, or the second back skip time (BS2) is before the start time (title begin time) for the video signal being played back (YES in step S83), the control section 8 carries out the processing of step S66 in FIG. 8. Specifically, the control section 8 displays only a video signal (first video signal) for the first skip time (FS1) or the first back skip time (BS1) (step S84).

As a result of the above described operation, when there is input no image signal corresponding to a playback time a predetermined time before or after the skip point time, it is easy for the user to determine that no skip point exists by seeing a display providing only the skip point image.

When there is no image corresponding to before or after the skip point, it may be displayed an image representing that fact.

With the above described third and fourth embodiments, in the case of skip playback or back skip playback operations, the first video signal is played back as a moving picture, and the second video signal is played back as a still picture, but it is also possible to display the first video signal and the second video signal on the display as still pictures.

### Fifth Embodiment

Next, as a fifth embodiment, description will be given for the case where, when there is input an instruction for skip playback or back skip playback, the first video signal, and the second video signal are displayed on the display 9 as still images. In order to facilitate understanding, description of structures that are the same as in the embodiments described above will be omitted.

When an instruction signal for skip playback or back skip playback is input from the operation section, the control section 8 calculates the first skip time (FS1) or the first back skip time (BS1), and the second skip time (FS2) or the second back skip time (BS2), based on the playback time when the instruction signal was input. The control section 8 reads out I frame data (first MPEG data, second MPEG data) from MPEG data of respective one GOPs containing video signals for the first skip time and the second skip time from the hard disk drive 3, and outputs to the decoder 4. The control section 8 decodes the first MPEG data and second MPEG data in the decoder 4, and the decoded first video signal and second video signal are stored in the output buffer memory 5a of the video output section 5.

The control section 8 controls the video signal output section 5 to create a composite video signal by combining the first video signal and the second video signal stored in the output buffer memory 5a of the video signal output section 5, and the composite video signal is output to the display 9.

The control section 8 is provided with a timer, not shown, for measuring a predetermined time (for example, 5 seconds) from a time of displaying an image for a skip point resulting from a skip playback or back skip playback operation. If an instruction signal to select any video signal is input from the operation section 6 as a result of a skip playback or back skip playback operation, the control section 8 reads out MPEG data continuous to the selected video signal from the hard disk drive 3, and decodes the data in the decoder 4. Next, the control section 8 carries out control so as to switch from a composite signal that is a combination of video signals output from the video signal output section 5 to the selected video signal, and output to the display 9.

Next, description will be given for processing in the case where a viewer inputs a skip playback or back skip playback instruction using the operation section 6 during playback of a video signal.

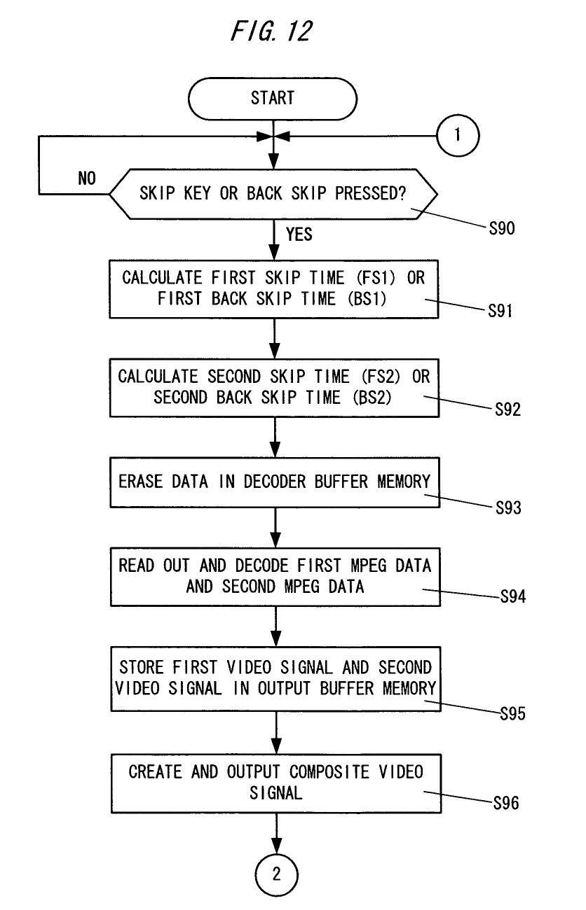

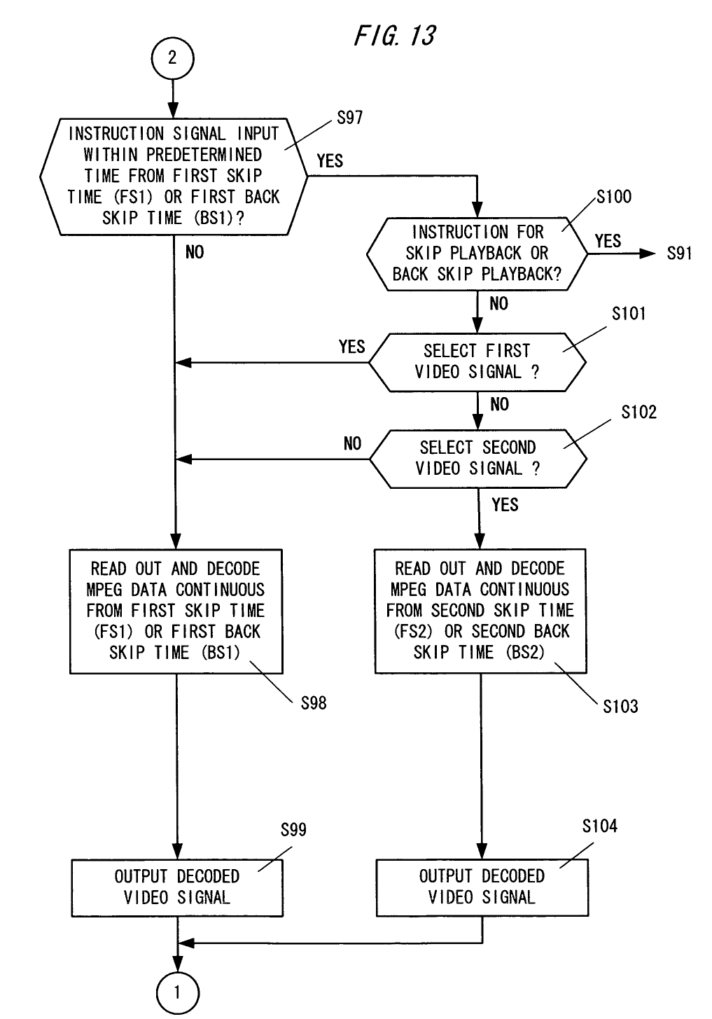

FIG. 12 is a flowchart showing operation of a fifth embodiment of the present invention from receipt of a skip playback or back skip playback instruction until display of a composite video signal. FIG. 13 is a flowchart showing operation of the fifth embodiment according to the invention after display of a composite video signal.

First of all, the control section 8 monitors for input of an instruction signal from the operation section 6 (step S90 in FIG. 12). If the viewer instructs skip playback or back skip playback using the operation section 6, the operation section 6 outputs a skip playback or back skip instruction signal to the control section 8.

The control section 8 calculates a first skip time (FS1) or a first back skip time (BS1) skipped a predetermined time from the playback time of a video signal being played back when an instruction signal for skip playback or back skip playback is input (step S91). The control section 8 next calculates a second skip time (FS2) or a second back skip time (BS2) based on the first skip time (FS1) or the first back skip time (BS1) (step S92).

The control section 8 erases data stored in the buffer memory 4a of the decoder 4 (step S93).

Based on the first skip time (FS1) or the first back skip time, and the second skip time (FS2) or the second back skip time (BS2), the control section 8 reads out first MPEG data from MPEG data for one GOP containing a first skip time (FS1) or a first back skip time (BS1) while also reading second MPEG data from MPEG data for one GOP containing the second skip point (BS2) or the second back skip point (BS2), among MPEG data stored in the hard disk drive 3, and controls the data to be decoded by the decoder 4 (step S94).

A first video signal and a second video signal decoded by the decoder 4 are stored in the output buffer memory 5a of the video output section 5 (step S95).

The video output section 5 creates a composite video signal using the first video signal and second video signal stored in the output buffer memory 5a, and outputs the composite video signal to the display 9 (step S96). The first video signal and the second video signal are displayed on the display 9 as still pictures.

Next, whether or not there is input an instruction signal from the operation section 6, within a predetermined time from the time when the composite signal consisting of the first video signal and the second video signal is displayed, is monitored using a timer, not shown (step S97). At this time, viewer operations include a skip playback instruction, a back skip playback instruction, a start playback instruction (instruction to commence playback from the first skip time), and an instruction to start playback from a second skip time or a second back skip time. Based on the viewer's operation, the operation section 6 outputs an instruction signal corresponding to the input instruction to the control section 8.

If there is input no instruction signal from the operation section 6 until a predetermined time after the time of displaying the composite signal (NO in step S97), the control section 8 reads and decodes MPEG data continuous from the first skip time (FS1) or the first back skip time (BS1) from the hard disk drive 3 (step S98), and outputs a video signal from the video signal output section 5 to the display 9 (step S99). Thus, an image at and after the first skip time (FS1) or the first back skip time (BS1) is displayed on the display 9 as a moving picture. After that, processing transfers to step S90, and the control section 8 monitors whether or not the skip key or the back skip key has been pressed down from the operation section 6.

In the case where an instruction signal is input from the operation section 6 (YES in step S97) within a predetermined time from the time when the composite signal is displayed, and the instruction signal is a skip playback instruction or a back skip playback instruction (when the skip playback key or back skip playback key has been newly pressed down) (YES in step S100), the control section 8 carries out the processing from step S91 in FIG. 12.

If the instruction signal is not a skip playback instruction or a back skip playback instruction (NO in step S100), it is determined whether or not the instruction signal is an instruction to select the first video signal (step S101).

If the instruction signal is an instruction to select and play back the first video signal (YES in step S101), MPEG data consecutive from the first skip time (FS1) or the first back skip time (BS1) is read from the hard disk drive 3 and decoded (step S98), and a video signal is output to the display 9 (step S99). After that, processing transfers to step S91 in FIG. 12.

If there is input no instruction to select the first video signal (NO in step S101), and there is also input no instruction to select a second video signal (Yes in step S102), MPEG data consecutive from the second skip time is read from the hard disk drive 3 and decoded (step S103), and a video signal is output from the video signal output section 5 to the display 9 (step S104). After that, processing transfers to step S91 of FIG. 12.

As a result of the above described processing, when the skip key or the back skip key has been pressed, a first video signal for the first skip time or first back skip time skipped a predetermined skip time, and a second video signal for a second skip time a predetermined time after the first skip time or for a second back skip time a predetermined time before the first back skip time, are displayed as still pictures on the display 9.

Thus, it is possible for the viewer to simultaneously see an image for a point that has been skipped for a predetermined skip time as a result of skip playback, and images for a predetermined time before or after the skip time. Also, it is possible to simultaneously see an image for a back skip point that has been skipped for the predetermined skip time as a result of back skip playback, and an image for a playback time that is a predetermined time before the image at the back skip point. It is therefore possible to determine whether or not the point skipped from the skip point or the back skip point is the desired skip point, and it is easy to determine whether or not it is necessary to perform another additional skip.

It is also possible to determine which is closest to the desired skip point among the image at the skip point due to skip playback, the image that is a predetermined time after the image at the skip point, and the image that is a predetermined time before the image at the skip point, to thereby easily determine whether or not a skip should be performed again.

Then, if the skip key or back skip key are pressed again when displaying images at the skip point, back skip point, or before and after the skip point and the back skip point, there is performed an additional skip for the skip time from the first skip point or the first back skip point. Also, if the playback start key is pressed, the first video signal is displayed on the display 9 from that time point. Also, if there is input an instruction to select the second video signal when displaying images for the skip point, back skip point or before and after the skip point and the back skip point, playback of the video signal commences from the selected second video signal, and a moving picture is displayed on the display 9.

In the above described embodiment, if a skip playback or back skip operation is carried out, a composite video signal created from the first video signal and second video signal is displayed on the display 9. However, by setting using the operation section 6, the user may select normal skip playback or back skip playback, that is, skip playback for playing back a video signal at the skip point or back skip point, and the above described skip playback or back skip playback.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of the invention.

The disclosure of Japanese Patent Application Nos. JP 2004-26492 filed on Feb. 3, 2004 and JP 2004-211796 filed on Jul. 20, 2004, including specification, claims, drawings and abstract is incorporated herein by reference in its entirety.

1. A video signal playback unit, comprising:
a record and playback section (3) for recording and playing back image data;
a skip operation section (6) for receiving skip playback instruction input resulting from user operation;
a calculating section (8) for calculating, based on the skip playback instruction input being input from the skip operation section (6), a first time skipped a predetermined time from a playback time at the time of input, and a second time obtained by adding a predetermined time to the first time; and
an output section (5) for outputting a first video signal for image data played back by the record and playback section (3), the first video signal being corresponding to the first time calculated by the calculating section (8), and a second video signal for image data played back by the record and playback section (3), the second image data being corresponding to the second time calculated by the calculating section (8).

2. The unit according to claim 1, wherein
the calculating section (8) calculates times a predetermined time before and after the first time.

3. The unit according to claim 2, wherein
the output section (5) outputs the first video signal made up of moving pictures, and outputs the second video signal made up of a still picture.

4. The unit according to claim 2, further comprising
a selection operation section (6) for receiving selection instruction input for selecting either of an output first video signal or an output second video signal output resulting from viewer operation, and wherein
when a selection instruction input for selecting either video signal is received from the selection operation section (6) within a predetermined time from the first time, the output section (5) outputs the selected video signal.

5. The unit according to claim 4, wherein
when a selection instruction input for selecting either video signal is not received from the selection operation section (6) within the predetermined time from the first time, the output section (5) outputs only the first video signal.

6. The unit according to claim 1, wherein
the calculating section (8) calculates a second time a predetermined time before or after the first time.

7. The unit according to claim 6, wherein
the output section (5) outputs the first video signal made up of moving pictures, and outputs the second video signal made up of a still picture.

8. The unit according to claim 6, further comprising
a selection operation section (6) for receiving selection instruction input for selecting either of an output first video signal or an output second video signal output resulting from viewer operation, and wherein
when a selection instruction input for selecting either video signal is received from the selection operation section (6) within a predetermined time from the first time, the output section (5) outputs the selected video signal.

9. The unit according to claim 8, wherein
when a selection instruction input for selecting either video signal is not received from the selection operation section (6) within the predetermined time from the first time, the output section (5) outputs only the first video signal.

10. The unit according to claim 1, wherein
when image data corresponding to the second skip time calculated by the calculating section (8) is not recorded in the record and playback section (3), the output section (5) does not output the second video signal.

11. A video signal playback method, comprising:
recording image data;
receiving skip playback instruction input resulting from user operation;
calculating, based on the skip playback instruction input being input, a first time skipped a predetermined time from a playback time at the time of input, and a second time obtained by adding a predetermined time to the first time; and
playing back and outputting a first video signal for recorded image data, the first video signal being corresponding to the calculated first time, and a second video signal for recorded image data, the second video signal being corresponding to the calculated second time.
